(19) United States
(12) Patent Application Publication
(10) Pub. No.: US 2024/0377070 A9
(43) Pub. Date: Nov. 14, 2024

(54) OVEN WITH DIVIDER HAVING ADJUSTABLE HEAT TRANSMISSION

(71) Applicant: WHIRLPOOL CORPORATION, Benton Harbor, MI (US)

(72) Inventors: Arun Kumar Aneladasu, Hyderabad (IN); Ankur Garg, Pune (IN); Sujay Sampat Shelke, Pune (IN); Reshmi Sil, Pune (IN); Gautham Reddy Sunkara, Visakhapatnam (IN)

(73) Assignee: WHIRLPOOL CORPORATION, Benton Harbor, MI (US)

(21) Appl. No.: 17/882,755

(22) Filed: Aug. 8, 2022

(51) Int. Cl. F24C 15/16; F24C 15/18; F26B 21/02

(52) U.S. Cl. CPC F24C 15/16; F24C 15/18; F26B 21/02

(57) ABSTRACT

A divider for an oven includes a first panel configured to spatially separate the oven cavity into respective upper and lower sub-cavities. The first panel defines a first plurality of apertures therethrough. A second panel is slidably mounted to the first panel and defines a second plurality of apertures that are collectively moveable relative to the first plurality of apertures by sliding of the second panel relative to the first panel between a heat transmission position and a closed position, wherein the ones of the second plurality of apertures are respectively aligned and unaligned with the respective ones of the first apertures. In various aspects, the divider may be configured as an integrated or permanently installed feature of an oven or may be a removable accessory for use with an oven.

### BACKGROUND OF THE DISCLOSURE

The present disclosure generally relates to an oven cavity divider, and more specifically, to an oven cavity with controlled thermal transmission.

### SUMMARY OF THE DISCLOSURE

According to one aspect of the present disclosure, a divider for an oven includes a first panel extending through a first length and a first width configured for the first panel to fit within an oven cavity, in contact with spaced-apart side walls of the oven cavity and a back wall of the oven cavity, to spatially separate the oven cavity into respective upper and lower sub-cavities. The first panel defines a first plurality of apertures therethrough. A second panel is slidably mounted to the first panel and defines a second plurality of apertures therethrough. The second plurality of apertures is collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed.

According to another aspect of the present disclosure, an oven includes an interior liner defining an oven cavity having spaced-apart side walls and a back wall and a first heat source in thermal communication with the oven cavity. A divider is positioned within the cavity and has a first panel extending through a first length and a first width configured for the first panel to fit within the interior cavity in contact with the spaced-apart side walls the back wall of the oven cavity to spatially separate the oven cavity into respective upper and lower sub-cavities. The first panel defines a first plurality of apertures therethrough. The divider further has a second panel slidably mounted to the first panel and defining a second plurality of apertures therethrough. The second plurality of apertures is collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed.

According to yet another aspect of the present disclosure, an oven includes an interior liner defining an oven cavity having spaced-apart side walls, a top wall, a bottom wall, and a back wall, a first heat source in thermal communication with the oven cavity and positioned beneath the bottom wall of the oven cavity, a second heat source in thermal communication with the oven cavity and positioned adjacent the top wall of the oven cavity, and a controller operably associated with the heat source. A divider is positioned within the cavity and has a first panel extending through a first length and a first width configured for the first panel to fit within the interior cavity in contact with the spaced-apart side walls the back wall of the oven cavity to spatially separate the oven cavity into respective upper and lower sub-cavities. The upper sub-cavity includes the top wall of the oven cavity, and the lower sub-cavity includes the bottom wall of the oven cavity. The first panel defines a first plurality of apertures therethrough. The divider also has a second panel slidably mounted to the first panel and defining a second plurality of apertures therethrough, the second plurality of apertures being collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed. A driving mechanism is coupled between a housing and the second panel and is configured for controllably moving the second panel relative to the first panel between the full heat transmission position and the closed position. The controller is further in operable communication with the driving mechanism to cause the driving mechanism to controllably move the second panel relative to the first panel.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a perspective view of an oven having a divider according to an aspect of the present disclosure;

FIG. 2 is a cross-sectional side view of the oven of FIG. 1;

FIG. 3 is a schematic view of the divider in a first position;

FIG. 4 is a schematic view of the divider in a second position;

FIG. 5 is a schematic view of a divider according to a further aspect of the disclosure in a first positon;

FIG. 6 is a schematic view of the divider of FIG. 5 in a second position;

FIG. 7 is a schematic view of the divider of FIG. 5 in a third position; and

FIG. 8 is a schematic view of a divider according to a further aspect of the disclosure.

The components in the figures are not necessarily to scale, emphasis instead being placed upon illustrating the principles described herein.

### DETAILED DESCRIPTION

The present illustrated embodiments reside primarily in combinations of method steps and apparatus components related to an oven. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

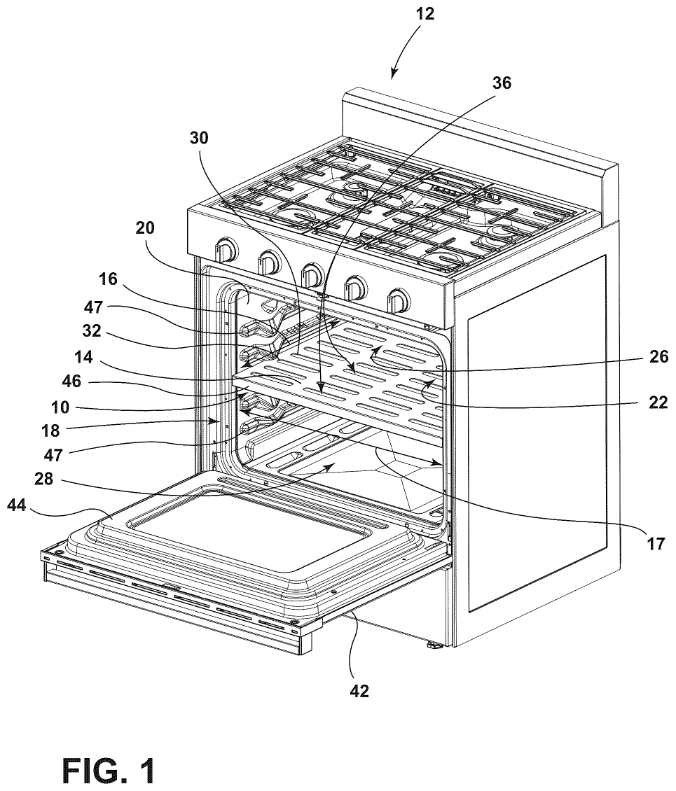

For purposes of description herein, the terms “upper,” “lower,” “right,” “left,” “rear,” “front,” “vertical,” “horizontal,” and derivatives thereof shall relate to the disclosure as oriented in FIG. 1. Unless stated otherwise, the term “front” shall refer to the surface of the element closer to an intended viewer, and the term “rear” shall refer to the surface of the element further from the intended viewer. However, it is to be understood that the disclosure may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

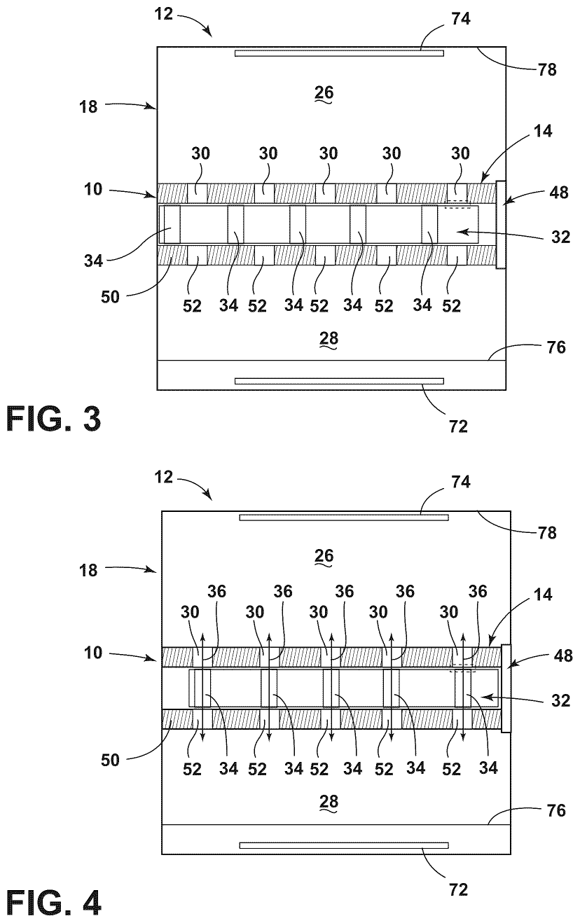

Referring to FIGS. 1-7, reference numeral 10 generally designates a divider for an oven 12. The divider 10 includes a first panel 14 extending through a first length 16 and a first width 17 configured for the first panel 14 to fit within an oven cavity 18, in contact with spaced-apart side walls 20 and 22 of the oven cavity 18 and a back wall 24 of the oven cavity 18, to spatially separate the oven cavity into respective first and second sub-cavities 26 and 28. The first panel 14 defines a first plurality of apertures 30 therethrough. A second panel 32 is slidably mounted to the first panel 14 and defines a second plurality of apertures 34 therethrough. The second plurality of apertures 34 is collectively moveable relative to the first plurality of apertures 30 by sliding of the second panel 32 relative to the first panel 14 between a heat transmission position (FIG. 4), wherein ones of the second plurality of apertures 34 are aligned with respective ones of the first plurality of apertures 30 to define transmission openings 36 corresponding in size with at least one of the first plurality of apertures 30 or the second plurality of apertures 34, and a closed position (FIG. 3), wherein the ones of the second plurality of apertures 34 are unaligned with the respective ones of the first plurality of apertures 30 such that the transmission openings 36 are closed.

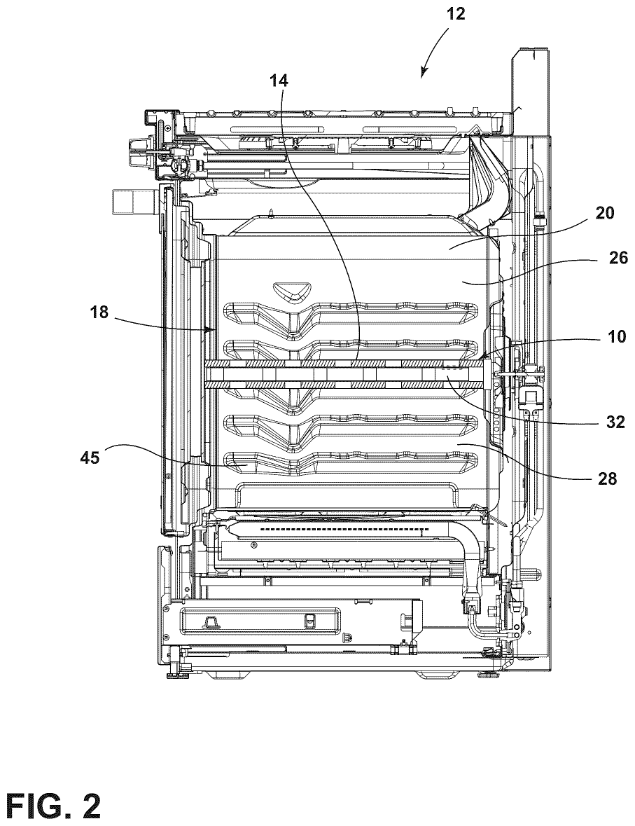

Referring more specifically to FIGS. 1 and 2, an example of an oven 12 with which the present divider 10 may be useable includes an interior liner 38 that defines the oven cavity 18, including the spaced-apart side walls 20 and 22, as well as the back wall 24 between which the divider 10 is configured to fit. As can be appreciated, the oven 12 further includes a first heat source 40 in thermal communication with the oven cavity 18. The oven 12 can be generally configured according to a number of known oven types with corresponding heat sources for use in connection with available energy sources, including gas burners, electrical heating coils, and combinations thereof. As shown, the divider 10 is positioned (either fixedly or removably, as discussed below) within the cavity 18, as discussed above, and in contact with the spaced-apart side walls 20 and 22 and the back wall 24 of the oven cavity 18, as defined by the liner 38 to spatially separate the oven cavity 18 into the first and second sub-cavities 26 and 28. As further shown, the oven 12 includes a door 42 to open and close access to the cavity 18, with the illustrated door 42 being merely exemplary of such a door and variations thereof (for example, depending on the type and configuration of the oven 12) being possible. In this manner, the divider 10 is configured to be in contact with the interior 44 of the door 42 when the door 42 is in the closed position, as shown in FIG. 2. In this manner, the divider 10 may be shaped along its front edge 46 to match the inner cross-sectional profile of the interior 44 of the door 42 such that generally consistent contact is made therewith. In other implementations, discussed further below, the divider 10 can be made, at least in part, of a compliant or resiliently deformable material so that it does not have to be specifically shaped for any particular oven door 42. The interaction of the divider 10 with the door 42 is such that the divider 10 serves to selectively isolate the first sub-cavity 26 from the second sub-cavity 28 when the oven 12 is operating with the door 42 in the closed position, according to the adjustability of the size of the transmission opening 36 mentioned above and discussed further below.

In various aspects, the divider 10 can be permanently affixed, or otherwise assembled, within the cavity 18. In one example, the divider 10 can be defined by separate portions of the liner 38 being integral with an upper portion of the cavity 18 that fully defines the first sub-cavity 26. Similarly, a lower portion of the cavity 18 can fully define the second sub-cavity 28 with a third panel (discussed further below) being integral therewith. A space can be defined between the adjacent portions of the cavity 18 that slidably receive the second panel 32 therebetween. In another example, the divider 10 can be a separate sub-assembly that is permanently fixed within the oven cavity 18, such as by being coupled with the side walls 20 and 22 and/or the back wall 24. The oven cavity 18 can include grooves or other supporting features to help retain the divider 10 in place. In various aspects, the divider 10 can be affixed within the cavity 18 using adhesives (including insulating adhesives) and/or mechanical fasteners, including screws, rivets, and the like. In a similar aspect, a divider 10 fabricated similar to the permanent divider discussed above and more fully below can be removably retained within the cavity 18, including by being adapted to fit on or between adjacent rack supports 47 that are formed into the side walls 20 and 22, with other support mechanisms, including specific support projections or grooves, being possible. In either of these aspects, the first panel 14 may be defined on a housing 48 of the divider 10 that slidably retains the second panel 32. As shown in FIG. 2, the housing 48 may further define a third panel 50 fixed with respect to the first panel 14 and defining a third plurality of apertures 52 therethrough. In this respect, the third plurality of apertures 52 can be aligned with respective ones of the first plurality of apertures 30 so that the second plurality of apertures 34 is collectively moveable relative to the first and third pluralities of apertures 30, 52 by the above-described sliding of the second panel 32 relative to the first panel 14, as shown schematically in FIGS. 3 and 4. Accordingly, in the heat transmission position (FIG. 4), respective ones of the second plurality of apertures 34 are aligned with respective ones of the first plurality of apertures 30, as discussed above, and with respective ones of the third plurality of apertures 52 to define the above-referenced transmission openings 36. In a similar manner, in the closed position, the second plurality of apertures 34 are unaligned with the first apertures 32 and the third apertures 52 such that the transmission openings 36 are closed.

As shown in FIG. 3, in the above-referenced unaligned position the second panel 32 is positioned relative to the first panel 14 such that the second plurality of apertures 34 are positioned laterally away from the first plurality of apertures 30. In other words, the second plurality of apertures 34 are aligned with solid portions 54 of the first panel 14 between the first plurality of apertures 30. In the illustrated example, wherein the divider 10 includes the housing 48 with third panel 50 opposite the first panel 14, the second plurality of apertures 34 are similarly aligned with solid portions 54 of the third panel 50 when in the unaligned position. As shown in FIG. 6, for example, movement of the second panel 32 from the unaligned position of FIG. 3 can begin to partially align the second apertures 34 with the first apertures 30 such that the transmission openings 36 are present in respective sizes less than the full size thereof in the heat transmission position shown in FIG. 4 and corresponding with the amount of overlap between the first apertures 30 and the second apertures 34. In this manner, the transmission openings can be varied in size by the positioning of the second panel 32 relative to the first panel 14, including through the range of positions available between the fully closed position (FIG. 3) and the heat transmission position (FIG. 4).

As can be appreciated, the divider 10 is intended to have the capability to thermally insulate the first sub-cavity 26 from the second sub-cavity 28 during operation of the oven 12, with the selective presence and adjustment of the transmission opening 36 allowing the level of thermal insulation to be controlled such that, depending on various conditions or cooking needs, the amount of thermal isolation can be reduced. Stated differently, the divider 10 can be configured to strategically allow or block heat transmission therethrough (i.e. from one sub-cavity 26 or 28 to the other) at an adjustable level. This adjustable level can be with respect to the rate at which heat is transmitted through the divider 10 from a minimum rate (corresponding with the unaligned position of FIG. 3) and a maximum rate (corresponding with the heat transmission position of FIG. 4), including the intermediate rates achieved with a position therebetween, as well as an actual amount of heat transmission over such time, which can be controlled or adjusted by real-time adjustment, including closing, of the position of the second panel 32 relative to the first panel 14. In this manner, the maximum rate of heat transmission through the divider 10 is a product of the relative area of the solid portions 54 of the first panel 14 to the total area of the first apertures 30. To allow for the above-described opening and closing of the transmission openings 36 by alignment of the second apertures 34 with the first apertures 30 or the solid portions 54, it can be appreciated that the theoretical maximum achievable open area is half of the total area of the first panel 14. In application, to achieve an acceptable minimum level of heat transmission (e.g., to achieve a temperature differential between sub-cavities 26 and 28 of at least about 60° C. and in one embodiment about 75° C.) the first apertures 30 can be structured to have a width (in the direction of movement of the second panel 32 relative to the first panel 14) that is less than a width of the solid portions 54 of the first panel 14, such that some overlap between solid portions 54 of the first panel 14 and the solid portions 54 of the second panel 32 is achieved when the second panel 32 is in the unaligned position, as shown in FIG. 3). This allows an advantageous level of heat-blocking material around the perimeters of the first apertures 30. Some additional overlap may be present to allow some tolerance in maintaining the fully closed position. Additionally, as shown in FIG. 1, the first apertures 30 and, optionally, the second apertures 34 may not extend fully across (e.g. perpendicular to the direction of travel of second panel 32), but instead may comprise a plurality of separate openings arranged laterally and longitudinally, as shown in FIG. 1.

To achieve the desired thermal isolation between the first and second sub-cavities 26 and 28, the divider 10 is constructed of or including insulating material. Notably, because the closed position of the divider 10 (FIG. 3) is such that the solid portions 54 of the first panel 14 are aligned with the second apertures 34 of the second panel 32, both the first panel 14 and the second panel 32 are made to be thermally insulating to achieve the desired maximum level of thermal isolation discussed above. In one example, both the first panel 14 and the second panel 32 can be fabricated in whole or in part of a silicone material, including, but not limited to, various food-compliant silicone sheeting materials. Significantly, various silicone materials exhibit low thermal conductivity (e.g., act as thermal insulators), low chemical reactivity, and high thermal stability. Depending on the rigidity of the selected silicone material, it can be applied or otherwise assembled with an internal supporting structure (e.g., of metal) or heat-resistant plastics, with which the silicone can be over- or co-molded, for example. In other examples, the first panel 14 and the second panel 32 can be fabricated from metal with internal insulation (e.g. fiberglass sheeting) applied thereto. In various applications, the panels 14 and 32 can be hollow and filled with such insulating material, or can be evacuated to define vacuum-insulating structures. In embodiments including the third panel 50 opposite the first panel 14, the third panel 50 can be of similar construction to the first panel 14, for example.

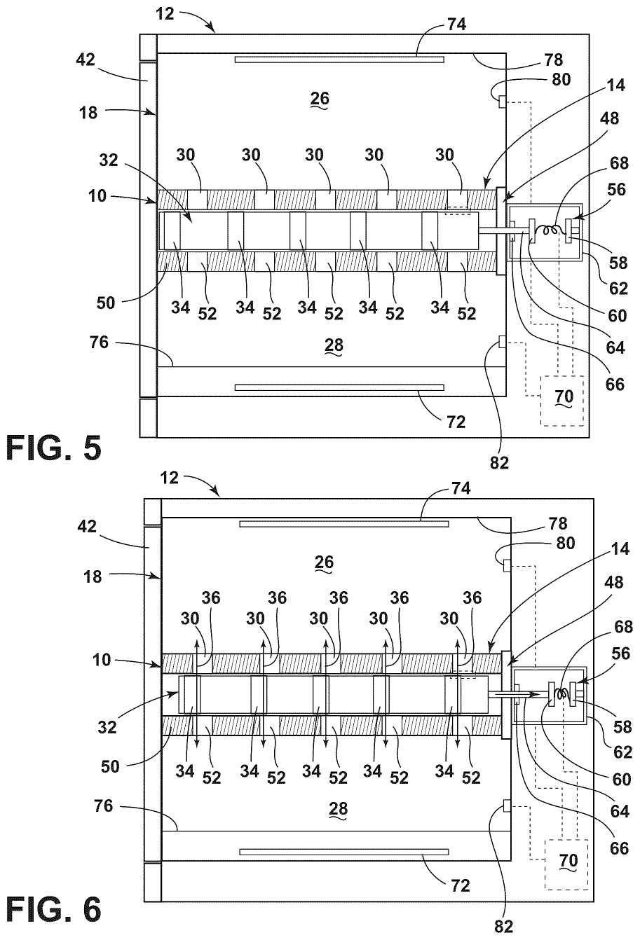

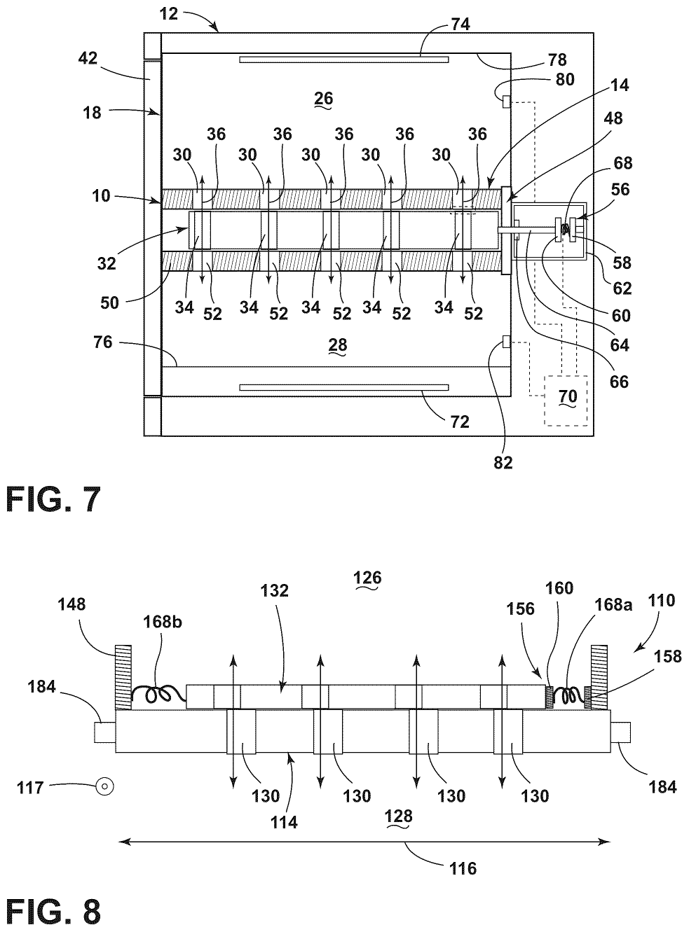

As further shown in the example of FIGS. 5-7, the divider 10 may further include a driving mechanism 56 operably fixed between the housing 48 and the second panel 32 and configured for controllably moving the second panel 32 relative to the first panel 14 between the full heat transmission position (FIG. 7) and the closed position (FIG. 5). The driving mechanism 56 may include an electromagnet element 58 fixedly coupled with either one of the housing 48 and the second panel 32 and a permanently magnetic element 60 fixedly coupled with the other one of the housing 48 and the second panel 32. In the illustrated example, the driving mechanism 56 is primarily positioned outside of the oven cavity 18 (e.g. on the outer side of the back wall 24) in a separate housing 62 that is rigidly affixed with the back wall 24. In this manner, the electromagnetic element 58 is fixed with the mechanism housing 62 such that it is operably fixed with respect to the first panel 14 (although other arrangements are possible). The permanent magnet 60 is operably fixed with the second panel 32 by a stem 64 that extends through a hole 66 in the back wall 24 (and, optionally, through a corresponding portion of the mechanism housing 62), the permanent magnet 60 being, thusly, slidably received within the housing 62 and moveable toward and away from the electromagnet element 58 with movement of the second panel 32 between the fully closed and fully heat-transmissive positions (FIGS. 5 and 7, respectively). A spring 68 is positioned between the permanent magnet 60 and the electromagnet element 58 and is arranged to push the permanent magnet 60 away from the electromagnet element 58 and, therefore, toward the closed position of FIG. 5.

In one example, the permanent magnet 60 can be a magnetized iron strip, although other known permanent magnets may be used to achieve desired properties and/or performance. Similarly, the electromagnet element 58 may consist of a non-magnetized iron strip that is wrapped in bare wire connected with a power source such that a current applied to the wire can induce magnetic behavior in the iron strip, with other known electromagnetic configurations being usable. Notably, the amount of current applied in the wire, or otherwise to the electromagnet 58, can be adjusted to control the strength of the magnetic response induced in the electromagnet 58. In this arrangement, the magnetic force of the electromagnet 58 can be adjustable to controllably move the permanent magnet 60 toward and away from the electromagnet 58 against the opposing force of the spring 68, which, by way of the connection between the permanent magnetic 60 and the second panel 32, serves to move the second panel 32 relative to the first panel 14. As discussed above, this movement controls opening and closing of the transmission openings 36. In this arrangement, the strength of the permanently magnetic element 60 and the spring 68, as well as the range of electromagnetic force achievable by the electromagnet 58 can be selected or adjusted to provide the desired movement of the second panel 32. In one aspect, the value of the spring 68 (i.e., the spring factor, or force achieved per distance compressed) can be selected to overcome any friction force (static and kinetic) between the second panel 32 and the first panel 14 and/or the third panel 50 or the housing 48, as applicable, such that the spring 68 can reliably move the second panel 32 from the full heat transmissive position (FIG. 7) to the fully closed position (FIG. 5), including when both the first sub-cavity 26 and the second sub-cavity 28 are heated to high temperatures. The strength of the permanently magnetic element 60 and the operable range of the electromagnet 58 can be similarly selected to overcome such friction, while also causing compression of the selected spring 68. In such a configuration, the adjustment of the electromagnet 58 to controllably move the permanently magnetic element 60, may include increasing a current flow of electricity to the electromagnet 58 within the operable range to cause compression of the spring 68 under movement of the second panel 32 by an amount corresponding with the magnetic force achieved by the particular current. In this manner, the current can be adjusted to achieve a particular size of the transmission openings 36. As discussed below, this can be done to control the rate of heat transmission between the sub-cavities 26 and 28.

As can be appreciated, the example of the divider 10 shown in FIGS. 5-7 is configured for preferred operation as a permanent feature of the related oven 12. In particular, the inclusion of the present driving mechanism 56 in the housing 48 positioned opposite the back wall 24 from the first panel 14, second panel 32, and third panel 50 is best adapted for an arrangement in which the housing 48 that defines the first and second panels 30, 32 and that encloses the second panel 32 is fixed within the cavity 18, including with the back wall 24, and in which the housing 62 of the driving mechanism 56 is affixed on the opposite side of the back wall 24. In this manner, the stem 64 extends through the above-referenced opening 36 in the back wall 24. It is contemplated that the depicted divider 10 can, however, be made removable, for example with a specifically designed oven 12 that includes a recess to accommodate the housing 62 of the driving mechanism 56, which can be affixed to the main housing 48. Alternatively, the housing 62 of the driving mechanism 56 can be integral with the main housing 48 with the entire divider 10 being sized to fit within the cavity 18, with it being understood that the maximum achievable area of the transmission openings 36 in comparison with the total area of the divider 10 may be reduced.

As further shown, in FIGS. 5-7, the oven 12 may further include a controller 70 configured to control the operation of the oven 12. In one aspect, the controller 70 can be a microcontroller or microprocessor in the form of a computer chip or other comparable structure operably associated with memory including one or more programs or firmware including commands for operation of the oven 12. In one aspect, the controller 70 may be configured to operate heat sources 72, 74 used for heating the cavity 18. As shown, the oven 12 has a lower heating element 72 that is configured as the primary heat source for a typical oven 12. In various aspects, the lower heating element 72 may be configured for operation using electricity (e.g. a resistive heating coil or ring) or gas (e.g., a burner) and may be positioned within the cavity 18 adjacent lower wall 76 or outside lower wall 76, which can be configured with one or more openings to allow heat from the lower heating element 72 to enter the cavity 18. The controller 70 can also be operably associated with the upper heating element 74 mounted to or otherwise positioned adjacent to an upper wall 78. As is appreciated, the upper heating element 74 may be of a typical “broiler” element and may also operate using electricity or gas (in some aspects, the heating elements are configured to operate on the same energy source). The controller 70 is, thusly configured to operate the heating elements 72 and 74 according to the heating program selected by the user, including but not limited to maintaining a predetermined temperature within the cavity 18, optionally for a predetermined duration of time. In connection with maintaining the selected temperature, the oven 12 can include a temperature sensor 80 with which the controller 70 is in communication. In this respect, the controller 70 can activate and deactivate the heating elements 72 or 74, as needed, or in some configurations, adjust the operational level of one or both heating elements 72 and 74 to maintain the desired temperature within the oven cavity 18. A variety of temperature sensors 80 can be used for this arrangement, including thermocouples or the like.

For specific operability of the oven 12 with the divider 10 described herein, the previously-described temperature sensor 80 can be located and configured for use in determining the temperature of the second sub-cavity 28, within which the lower heating element 72 is positioned. Additionally, the oven 12 can include an additional temperature sensor 82 located and configured for use by the controller 70 (with which temperature sensor 82 is operably connected) in determining the temperature of the first sub-cavity 26, within which the upper heating element 74 is positioned. In this configuration, the controller 70 can operate in a specific mode wherein the divider 10 is in the fully closed position (FIG. 5) and the controller 70 uses the lower heating element 74 in connection with temperature sensor 80 to maintain the second sub-cavity 28 at one selected temperature, while using the first sub-cavity 26 in connection with the temperature sensor 82 at another selected temperature. In one respect, this type of operation can be used to reduce the energy needed to attain the desired temperature within one of the sub-cavities 26 or 28, as the volume to be heated is smaller.

Additionally, the controller 70 can be in operable communication with the driving mechanism 56 to control the above-described movement of the second panel 32 relative to the first panel 14. As discussed above, this allows selective heat-transmission between the first sub-cavity 26 and the second sub-cavity 28 by opening and closing, as well as intermediate adjustment of the transmission opening 36. In various examples, the controller 70 can provide a current to the electromagnet 58 directly or can cause current to be provided to the electromagnet 58 at a rate to achieve the desired movement of second panel 32 relative to first panel 14, via a separate electronic component. The amount of current provided can be calculated based on an initial calibration or can be controlled to achieve a desired actual movement, as monitored by a sensor within the divider 10 (e.g., a photo sensor, Hall-Effect sensor, potentiometer, etc.). According to an object of the present disclosure, the controller 70, by controlling the presence and absence and/or the particular size of the transmission openings 36, can controllably use the heat from one sub-cavity 26 or 28 (i.e., the one in which the associated heating element 72 or 74 is operating) to heat the other sub-cavity 28 or 26 (i.e., without using the heating element 74 or 72 in or associated with that sub-cavity 28 or 26.

In one aspect, the controller 70 can be configured to determine a desired heating configuration and control of the presence and/or size of the heat transmission openings 36 of divider 10 to maintain selected temperatures between the two sub-cavities 26 and 28. In one aspect, this can include using divider 10 to controllably heat the one of the sub-cavities 26 and 28 that has a lower set temperature by transmission of heat from the other of the sub-cavities 28 or 26 that has a higher set temperature (or resulting temperature in the case of a broiling mode). In one example, a user can select a broil mode for the first sub-cavity 26 on a high setting, which is intended to cook meat or the like using the upper heating element 74 and a “bake” mode for the second sub-cavity 28 at a set temperature of 350° F. In this configuration, the controller 70 can initially operate the driving mechanism 56 to configure the divider 10 in the fully open position (FIG. 5) to use heat from the broil operation in the first sub-cavity 26 to heat the second sub-cavity 28 to the desired temperature. As the temperature in the second sub-cavity 28 approaches the set (e.g., 350° F.) temperature, the controller 70 can operate the driving mechanism 56 to reduce the size of the transmission openings 36 to slow the heat transmission such that at temperature overshoot in second sub-cavity 28 is avoided. When the set temperature for the second sub-cavity 28 is reached, the controller 70 can close the divider 10 to stop the increase in temperature and can re-open the divider 10 (including to an intermediate position, such as that shown in FIG. 4) upon the temperature in the second sub-cavity 28 dropping below the present temperature (or a lower tolerance temperature). If the heat from the first sub-cavity 26 is insufficient for fully heating the second sub-cavity 28 to the desired temperature, the lower heating element 72 can be used to supplement the transmitted heat, as needed.

In another example, the user can select a bake mode for operation of the second sub-cavity 28 at a high temperature (e.g., 450° F.) or a roast mode, while selecting to operate the first sub-cavity 26 in a “warm” mode (e.g., between about 175° and 200° F.). In this configuration, the controller 70 can operate the lower heating element 72 to achieve and maintain the desired temperature within the second sub-cavity 28, while controlling the driving mechanism 56 of the divider 10 to allow heat from the second sub-cavity 28 to heat the first sub-cavity 26 to the desired lower temperature. The controller 70 can select a particular size for the transmission openings 36, for example, based on the temperature differential between the sub-cavities 26 and 28, as well as between the measured temperature within the first sub-cavity 26 (as indicated by the temperature sensor 80 associated with the first sub-cavity 26) and the set temperature for the first sub-cavity). For example, when the measured temperature of the first sub-cavity 26 is well below the set temperature thereof (e.g., at least 50° F. difference) the controller can position divider 10 in the fully open configuration. When the temperature of the first sub-cavity 26 approaches the set temperature, the controller 70 can reduce the size of transmission openings 36 to avoid a temperature overshot. This can be done in a progressive manner until the desired temperature of the first sub-cavity 26 is reached. Additionally, should the temperature in the first sub-cavity 26 subsequently fall outside a predetermined tolerance range of the set temperature (e.g., five degrees) the controller 70 can open the transmission openings 36 by an amount proportional to the difference between the measured temperatures in the first and second sub-cavities 26 and 28 to avoid heating the first sub-cavity 26 too rapidly, with a higher temperature differential resulting in a smaller opening size. In the present example, the openings 36 may be moved into a 20% open position in response to the temperature of the first sub-cavity 26 being below 170° F. when the second sub-cavity 28 is at a temperature of 450° F., although other configurations are possible. Other similar heating modes are possible according to the principles and construction of the divider 10 and related oven 12, as described herein.

Turning to FIG. 8, another example of a divider 110 is shown that is of similar construction to and is similarly useable as the divider 10 discussed above. The present divider 110 is structured to be removable from the associated oven, which may be similar to the oven 12 and variations thereof discussed above. In one aspect, the divider 110 is configured to slide into the oven cavity 18 in a direction toward the back wall 24 and may include side support flanges 182 to engage with rack supports 47 to maintain the divider 110 in a desired position within the oven cavity 18. As discussed above with respect to divider 10, the present divider 110 includes a first panel 114 extending through a first length 116 and a first width 117 configured for the first panel 114 to fit within oven cavity 18, in contact with spaced-apart side walls 20 and 22 of the oven cavity 18 and a back wall 24 of the oven cavity 18, to spatially separate the oven cavity 18 into respective first and second sub-cavities 126 and 128. The first panel 114 defines a first plurality of apertures 130 therethrough. A second panel 132 is slidably mounted to the first panel 114 and defines a second plurality of apertures 134 therethrough. The second plurality of apertures 134 is collectively moveable relative to the first plurality of apertures 130 by sliding of the second panel 132 relative to the first panel 114 between a heat transmission position, wherein ones of the second plurality of apertures 134 are aligned with respective ones of the first plurality of apertures 130 to define transmission openings 136 corresponding in size with at least one of the first plurality of apertures 130 or the second plurality of apertures 134, and a closed position wherein the ones of the second plurality of apertures 134 are unaligned with the respective ones of the first plurality of apertures 130 such that the transmission openings 136 are closed. As can be appreciated, the depiction of the divider 110 shown in FIG. 8 represents the divider 110 in a configuration wherein the second panel 132 is positioned relative to the first panel 114 such that the transmission openings 36 are in an intermediate position generally analogous to the position of divider 10 shown in FIG. 6, with it being understood that, as discussed above, the divider 110 is further configurable in the fully closed and fully open positions in a manner similar to the depiction of divider 10 in FIGS. 5 and 7, respectively. Aside from the specific differences discussed herein, divider 110 can be similarly constructed to the divider 10 discussed above, including being fabricated from similar materials to achieve a similar thermally-isolating effect between sub-cavities 126 and 128.

Still referring to FIG. 8, the divider 110 can include an outer frame 148 to which the first panel 114 is rigidly coupled and within which the second panel 132 is slidably disposed. As mentioned above, the second panel 132 can be configured to slide relative to first panel 114 in the direction of the width 17 of the first panel 114 (the second panel 32 of the divider 10 being configured to slide in the length 16 direction) such that the openings 136 are adjustable along the width 117, but are fixed (and in an embodiment elongated) in the length 16 direction. The divider 110 is shown as including a driving mechanism 156 operably fixed between the frame 148 and the second panel 132 and configured for controllably moving the second panel 132 relative to the first panel 114 between the full heat transmission position and the closed position. The driving mechanism 156 includes an electromagnet element 158 fixedly coupled with the frame 148 and the second panel 132 and a permanently magnetic element 160 fixedly coupled with the second panel 132. A first spring 168a is positioned between the permanent magnet 160 and the electromagnet 158 and is arranged to urge the permanent magnet 160 away from the electromagnet 158 and, therefore, toward the closed position. A second spring 168b can be positioned opposite the first spring 168a and can be similarly configured to help urge the second panel 132 to the closed position.

As discussed above, the amount of current applied in the electromagnet 158, can be adjusted to control the strength of the magnetic response induced in the electromagnet 158. In this arrangement, the magnetic force of the electromagnet 158 can be adjustable to controllably move the permanently magnet element 160 toward and away from the electromagnet 158 against the collective opposing force of the springs 168a and 168b, which, by way of the connection between the permanently magnetic element 160 and the second panel 132, serves to move the second panel 132 relative to the first panel 114. As discussed above, this movement controls opening and closing of the transmission openings 136. In this arrangement, the strength of the permanently magnetic element 160 and the springs 168a and 168b, as well as the range of electromagnetic force achievable by the electromagnet 158 can be selected or adjusted to provide the desired movement of the second panel 132.

Notably, by positioning the driving mechanism 156 within the frame 148, the divider 110 can be removably received within the oven cavity 18, without adaptation to the oven cavity 18 to accommodate an external driving mechanism 156. The oven 12 can be adapted, in other ways to control operation of the divider 110 in a similar manner to that which is discussed above, including by providing a communicative connection between the controller 70 and the divider 110, which may include a connection configured to mate with a complimentary connection on the divider or by a wireless connection (e.g. Bluetooth™) or the like. In other aspects, the divider 110 may include its own internal temperature sensors disposed thereon for measuring the temperature in the first sub-cavity 126 and the second sub cavity 128 and can include its own controller connected with the temperature sensors and the driving mechanism 156 for self-operation according to instructions that may be delivered to the user (e.g., via a smartphone application or the like). It is also to be appreciated that a divider 110 according to the description herein can also be permanently installed or otherwise arranged within an oven 12.

The invention disclosed herein is further summarized in the following paragraphs and is further characterized by combinations of any and all of the various aspects described therein.

In one aspect, a divider for an oven includes a first panel extending through a first length and a first width configured for the first panel to fit within an oven cavity, in contact with spaced-apart side walls of the oven cavity and a back wall of the oven cavity, to spatially separate the oven cavity into respective upper and lower sub-cavities. The first panel defines a first plurality of apertures therethrough. A second panel is slidably mounted to the first panel and defines a second plurality of apertures therethrough. The second plurality of apertures is collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed.

In a divider according to paragraph [0038], movement of the second panel between the closed and open positions can cause a size of the transmission openings to vary in area between zero and a maximum opening are defined by the size of the one of the first apertures and the second apertures.

In the divider according to either paragraph [0038] and [0039] and the first panel may be defined on a housing of the divider that slidably retains the second panel.

In the divider according to paragraph [0040] the housing may further define a third panel fixed with respect to the first panel and defining a third plurality of apertures therethrough, the third plurality of apertures being aligned with respective ones of the first plurality of apertures.

The divider according to either paragraph [0040] or [0041] may further include a driving mechanism coupled between the housing and the second panel and configured for controllably moving the second panel relative to the first panel between the full heat transmission position and the closed position.

In the divider of paragraph [0042], the driving mechanism may include an electromagnet fixedly coupled with one of the housing and the second panel, a permanently magnetic element fixedly coupled with the other of the housing and the second panel, and a spring coupled in an opposing relationship between the electromagnet and the permanently magnetic element.

In the divider of paragraph [0043] a magnetic force of the electromagnet may be adjustable to controllably move the electromagnet toward and away from the permanently magnetic element against the opposing force of the spring.

In the divider of paragraph [0044] adjustment of the electromagnet to controllably move the electromagnet toward the permanent magnet may move the second panel relative to the first panel from the closed position to the heat transmission position.

In the divider of either paragraph [0044] or [0045] the adjustment of the electromagnet to controllably move the permanent magnet may include increasing a current flow of electricity to the electromagnet.

According to another aspect, an oven includes an interior liner defining an oven cavity having spaced-apart side walls and a back wall and a first heat source in thermal communication with the oven cavity. A divider is positioned within the cavity and has a first panel extending through a first length and a first width configured for the first panel to fit within the interior cavity in contact with the spaced-apart side walls the back wall of the oven cavity to spatially separate the oven cavity into respective upper and lower sub-cavities. The first panel defines a first plurality of apertures therethrough. The divider further has a second panel slidably mounted to the first panel and defining a second plurality of apertures therethrough. The second plurality of apertures is collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed.

The oven of paragraph [0047] may further include a controller operably associated with the heat source.

In the oven of paragraph [0048] the divider may further include a driving mechanism coupled between the housing and the second panel and configured for controllably moving the second panel relative to the first panel between the full heat transmission position and the closed position, and the controller can further be in operable communication with the driving mechanism to cause the driving mechanism to controllably move the second panel relative to the first panel.

In the oven of paragraph [0049] the heat source can be adjacent the first sub-cavity with the divider positioned between the heat source and the second sub-cavity, and the controller can be configured to cause the driving mechanism to controllably move the second panel relative to the first panel to selectively allow heat from the heat source within the first sub-cavity to enter the second sub-cavity.

The oven of any of paragraphs [0048] to [0050] can further include a first temperature sensor operably associated with the first oven cavity and a second temperature operably associated with the second oven cavity, the controller being in electronic communication with the first and second temperature sensors, and the controller can be configured to control the heat source to maintain a first temperature within the first sub-cavity, while causing the driving mechanism to controllably move the first panel relative to the second panel to allow the heat entering the second sub-cavity to heat the second sub-cavity to a second predetermined temperature.

In the oven of paragraph [0051] the first predetermined temperature can be higher than the second predetermined temperature.

In the oven of either paragraph [0051] or [0052] the first sub-cavity can be positioned below the second sub-cavity and can include a lower wall of the oven cavity, and the heat source can be positioned below the lower wall of the oven cavity.

In the oven of either of paragraphs [0051] or [0052], the first sub-cavity can be positioned above the second sub-cavity and can include an upper wall of the oven cavity, and the heat source can be positioned adjacent the upper wall of the oven cavity.

In the oven of any of paragraphs[0049] to [0054] the driving mechanism can include an electromagnet fixedly coupled with one of the housing and the second panel, a permanently magnetic element fixedly coupled with the other of the housing and the second panel, and a spring coupled in an opposing relationship between the electromagnet and the permanently magnetic element.

In the oven of paragraph [0055] a magnetic force of the electromagnet can be adjustable to controllably move the electromagnet toward and away from the permanently magnetic element against the opposing force of the spring.

In the oven of paragraph [0056] adjustment of the electromagnet to controllably move the electromagnet toward the permanent magnet can move the second panel relative to the first panel from the closed position to the heat transmission position.

In the oven of either paragraph [0056] or [0057], the adjustment of the electromagnet to controllably move the permanent magnet can include increasing a current flow of electricity to the electromagnet.

According to another aspect, an oven includes an interior liner defining an oven cavity having spaced-apart side walls, a top wall, a bottom wall, and a back wall, a first heat source in thermal communication with the oven cavity and positioned beneath the bottom wall of the oven cavity, a second heat source in thermal communication with the oven cavity and positioned adjacent the top wall of the oven cavity, and a controller operably associated with the heat source. A divider is positioned within the cavity and has a first panel extending through a first length and a first width configured for the first panel to fit within the interior cavity in contact with the spaced-apart side walls the back wall of the oven cavity to spatially separate the oven cavity into respective upper and lower sub-cavities. The upper sub-cavity includes the top wall of the oven cavity, and the lower sub-cavity includes the bottom wall of the oven cavity. The first panel defines a first plurality of apertures therethrough. The divider also has a second panel slidably mounted to the first panel and defining a second plurality of apertures therethrough, the second plurality of apertures being collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed. A driving mechanism is coupled between the housing and the second panel and is configured for controllably moving the second panel relative to the first panel between the full heat transmission position and the closed position. The controller is further in operable communication with the driving mechanism to cause the driving mechanism to controllably move the second panel relative to the first panel.

The oven according to paragraph [0059] can further include a first temperature sensor operably associated with the first oven cavity and a second temperature sensor operably associated with the second oven cavity, and the controller can be in electronic communication with the first and second temperature sensors.

In the oven according to either paragraph [0059] or [0060] the controller can be configured to selectively control the first heat source and the second heat source to heat a selected one of the upper and lower sub-cavities to a first temperature using the respective one of the first heat source and the second heat source and to control the driving mechanism to allow heat from the one of the upper or lower sub-cavity to heat the other of the upper or lower sub-cavity at a second temperature that is lower than the first temperature.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

What is claimed is:

1. A divider for an oven, comprising:
a first panel extending through a first length and a first width configured for the first panel to fit within an oven cavity, in contact with spaced-apart side walls of the oven cavity and a back wall of the oven cavity, to spatially separate the oven cavity into respective upper and lower sub-cavities, the first panel defining a first plurality of apertures therethrough; and
a second panel slidably mounted to the first panel and defining a second plurality of apertures therethrough, the second plurality of apertures being collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed.

2. The divider of claim 1, wherein:
movement of the second panel between the closed and open positions causes a size of the transmission openings to vary in area between zero and a maximum opening are defined by the size of the one of the first apertures and the second apertures.

3. The divider of claim 1, wherein the first panel is defined on a housing of the divider that slidably retains the second panel.

4. The divider of claim 3, wherein the housing further defines a third panel fixed with respect to the first panel and defining a third plurality of apertures therethrough, the third plurality of apertures being aligned with respective ones of the first plurality of apertures.

5. The divider of claim 3, further including a driving mechanism coupled between the housing and the second panel and configured for controllably moving the second panel relative to the first panel between the full heat transmission position and the closed position.

6. The divider of claim 5, wherein the driving mechanism includes an electromagnet fixedly coupled with one of the housing and the second panel, a permanently magnetic element fixedly coupled with the other of the housing and the second panel, and a spring coupled in an opposing relationship between the electromagnet and the permanently magnetic element, wherein a magnetic force of the electromagnet is adjustable to controllably move the electromagnet toward and away from the permanently magnetic element against an opposing force of the spring.

7. The divider of claim 6, wherein adjustment of the electromagnet to controllably move the electromagnet toward the permanent magnet moves the second panel relative to the first panel from the closed position to the heat transmission position.

8. The divider of claim 6, wherein adjustment of the electromagnet to controllably move the permanent magnet includes increasing a current flow of electricity to the electromagnet.

9. An oven, comprising:
an interior liner defining an oven cavity having spaced-apart side walls and a back wall;
a first heat source in thermal communication with the oven cavity;
a divider positioned within the cavity and including:
a first panel extending through a first length and a first width configured for the first panel to fit within the oven cavity in contact with the spaced-apart side walls the back wall of the oven cavity to spatially separate the oven cavity into respective first and second sub-cavities, the first panel defining a first plurality of apertures therethrough; and
a second panel slidably mounted to the first panel and defining a second plurality of apertures therethrough, the second plurality of apertures being collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed.

10. The oven of claim 9, further including a controller operably associated with the first heat source, wherein:
the divider further includes a driving mechanism coupled between the first panel and the second panel and configured for controllably moving the second panel relative to the first panel between the full heat transmission position and the closed position, the controller being further in operable communication with the driving mechanism to cause the driving mechanism to controllably move the second panel relative to the first panel.

11. The oven of claim 10, wherein:
the first heat source is adjacent the first sub-cavity with the divider positioned between the heat source and the second sub-cavity; and
the controller is configured to cause the driving mechanism to controllably move the second panel relative to the first panel to selectively allow heat from the first heat source within the first sub-cavity to enter the second sub-cavity.

12. The oven of claim 11, further including a first temperature sensor operably associated with the first sub-cavity and a second temperature operably associated with the second sub-cavity, the controller being in electronic communication with the first and second temperature sensors, wherein:
the controller is configured to control the heat source to maintain the first temperature within the first sub-cavity, while causing the driving mechanism to controllably move the second panel relative to the first panel to allow the heat within the first sub-cavity to heat the second sub-cavity to a second predetermined temperature.

13. The oven of claim 12, wherein the first predetermined temperature is higher than the second predetermined temperature.

14. The oven of claim 11, wherein:
the first sub-cavity is positioned below the second sub-cavity and includes a lower wall of the oven cavity; and
the first heat source is positioned below the lower wall of the oven cavity.

15. The oven of claim 11, wherein:
the first sub-cavity is positioned above the second sub-cavity and includes an upper wall of the oven cavity; and
the first heat source is positioned adjacent to the upper wall of the oven cavity.

16. The oven of claim 10, wherein the driving mechanism includes an electromagnet fixedly coupled with one of the housing and the second panel, a permanently magnetic element fixedly coupled with the other of the housing and the second panel, and a spring coupled in an opposing relationship between the electromagnet and the permanently magnetic element, wherein a magnetic force of the electromagnet is adjustable to controllably move the electromagnet toward and away from the permanently magnetic element against an opposing force of the spring.

17. The oven of claim 16, wherein adjustment of the electromagnet to controllably move the electromagnet toward the permanent magnet moves the second panel relative to the first panel from the closed position to the heat transmission position.

18. The oven of claim 16, wherein adjustment of the electromagnet to controllably move the permanent magnet includes increasing a current flow of electricity to the electromagnet.

19. An oven, comprising:
an interior liner defining an oven cavity having spaced-apart side walls, a top wall, a bottom wall, and a back wall;
a first heat source in thermal communication with the oven cavity and positioned beneath the bottom wall of the oven cavity;
a second heat source in thermal communication with the oven cavity and positioned adjacent the top wall of the oven cavity;
a controller operably associated with the heat source; and
a divider positioned within the cavity and including:
a first panel extending through a first length and a first width configured for the first panel to fit within the interior cavity in contact with the spaced-apart side walls the back wall of the oven cavity to spatially separate the oven cavity into respective upper and lower sub-cavities, the upper sub-cavity including the top wall of the oven cavity, and the lower sub-cavity including the bottom wall of the oven cavity, the first panel defining a first plurality of apertures therethrough; and
a second panel slidably mounted to the first panel and defining a second plurality of apertures therethrough, the second plurality of apertures being collectively moveable relative to the first plurality of apertures by sliding of the second panel relative to the first panel between a heat transmission position, wherein ones of the second plurality of apertures are aligned with respective ones of the first plurality of apertures to define transmission openings corresponding in size with at least one of the first apertures or the second apertures, and a closed position, wherein the ones of the second plurality of apertures are unaligned with the respective ones of the first apertures such that the transmission openings are closed; and
a driving mechanism coupled between a housing and the second panel and configured for controllably moving the second panel relative to the first panel between the full heat transmission position and the closed position, the controller being further in operable communication with the driving mechanism to cause the driving mechanism to controllably move the second panel relative to the first panel.

20. The oven of claim 19, further including a first temperature sensor operably associated with the first oven cavity and a second temperature sensor operably associated with the second oven cavity, the controller being in electronic communication with the first and second temperature sensors wherein:
the controller is configured to selectively control the first heat source and the second heat source to heat a selected one of the upper and lower sub-cavities to the first temperature using the respective one of the first heat source and the second heat source and to control the driving mechanism to allow heat from the one of the upper or lower sub-cavity to heat the other of the upper or lower sub-cavity at a second temperature that is lower than the first temperature.
